(19) United States
(12) Patent Application Publication
(10) Pub. No.: US 2010/0140363 A1
(43) Pub. Date: Jun. 10, 2010

(54) Air powered terminal unit and system

(76) Inventors: Joachim Hirsch, Colleyville, TX (US); Michael C. Winn, Plano, TX (US)

Correspondence Address: Jeffrey Thurnau;The Gates Corporation, IP Law Dept. 10-A3, 1551 Wewatta Street, Denver, CO, 80202, US

(21) Appl. No.: 12/315,707

(22) Filed: Dec. 5, 2008

(51) Int. Cl. G05D 23/13

(52) U.S. Cl. 236/12.1

(57) ABSTRACT

An air powered terminal unit comprising a housing, a fluid to air heat exchanger, an induced flow air inlet upstream of the heat exchanger, a venturi downstream of the heat exchanger, a nozzle cooperatively disposed with the venturi so as to direct a primary air jet discharged from the nozzle through the venturi, such that an air flow through the heat exchanger is induced, and an outlet downstream of the venturi for discharging a mixture of the induced flow air and the primary air.

### FIELD OF THE INVENTION

The invention relates to an air powered terminal unit and system, and more particularly, to an air powered terminal unit comprising a housing, a fluid to gas heat exchanger, an induced flow gas inlet upstream of the heat exchanger, a venturi downstream of the heat exchanger, a nozzle cooperatively disposed with the venturi so as to direct a primary gas jet through the venturi, and a mixed gas outlet downstream of the venturi.

### BACKGROUND OF THE INVENTION

The primary function of terminal units is to provide a regulated or controlled air flow to an individual zone or room in response to a zone temperature requirement. A centralized air handler provides 100% of the chilled supply air (normally 55 F) or heated air (normally 85 F) to the terminal via duct work. Terminals may be equipped with a fan to compensate for individual supply air needs, like heating or cooling in perimeter zones. Current applications also allow for air to be admitted from a ceiling plenum and or heated in a heat exchanger.

Representative of the art is U.S. Pat. No. 3,390,720 which discloses a comfort conditioning system for supplying conditioned air to a room, a system having a box for mixing conditioned air with either room air or heated air from a plenum, or both. The mixing box, which is mounted flush in a dropped ceiling, has two opposed openings in its surfaces; one opening leads to the room and the other leads to the plenum. Two spaced apart faces are pivotally mounted over the openings such that at extreme positions one of the openings is covered and the other is uncovered and at intermediate positions both openings are uncovered in varying degrees. Conditioned air passes through a nozzle to increase its velocity, mixes with secondary air from the uncovered openings, and enters the room. Room temperature is regulated by a controlled motor which operates the two pivotally mounted faces.

What is needed is an air powered terminal unit and system, and more particularly, to an air powered terminal unit comprising a housing, a fluid to gas heat exchanger, an induced flow gas inlet upstream of the heat exchanger, a venturi downstream of the heat exchanger, a nozzle cooperatively disposed with the venturi so as to direct a primary gas jet through the venturi, and a mixed gas outlet downstream of the venturi. The present invention meets this need.

### SUMMARY OF THE INVENTION

The primary aspect of the invention is to provide an air powered terminal unit and system, and more particularly, to an air powered terminal unit comprising a housing, a fluid to gas heat exchanger, an induced flow gas inlet upstream of the heat exchanger, a venturi downstream of the heat exchanger, a nozzle cooperatively disposed with the venturi so as to direct a primary gas jet through the venturi, and a mixed gas outlet downstream of the venturi.

Other aspects of the invention will be pointed out or made obvious by the following description of the invention and the accompanying drawings.

The invention comprises an air powered terminal unit comprising a housing, a fluid to air heat exchanger, an induced flow air inlet upstream of the heat exchanger, a venturi downstream of the heat exchanger, a nozzle cooperatively disposed with the venturi so as to direct a primary air jet discharged from the nozzle through the venturi, such that an air flow through the heat exchanger is induced, and an outlet downstream of the venturi for discharging a mixture of the induced flow air and the primary air.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a schematic diagram illustrating the air flow for the system of this invention.

FIG. 2 is a plan view of a terminal housing.

FIG. 3 is a side cross-sectional view of a terminal unit.

FIG. 4 illustrates an alternate arrangement for the room air or return air grill work.

FIG. 5 illustrates an alternate side cross-sectional view of the active chilled terminal unit with the aspirator device.

FIG. 6 illustrates an alternate side cross-sectional of the active chilled terminal unit with the aspirator device.

FIG. 7 is a perspective view of the embodiment in FIG. 5.

FIG. 8 is a plan view of the embodiment in FIG. 7.

FIG. 9 is a perspective view of the embodiment in FIG. 6.

FIG. 10 is a perspective view of the embodiment in FIG. 5.

FIG. 11 is a side view of the embodiment in FIG. 5.

FIG. 12 is a perspective view of the embodiment in FIGS. 6 and 9.

### DETAILED DESCRIPTION OF THE PREFERRED EMBODIMENT

The system comprises a central air handling (CAH) unit which is remote from a room and is connected to a terminal unit. The system transmits conditioned air from the CAH to the terminal unit to the room. The system further comprises duct work for receiving and transmitting return air from the room to the terminal unit. A mixing chamber is provided for mixing fresh air from the exterior of the facility with a portion of the return air in the terminal unit.

The terminal unit controls the temperature of the conditioned air to be discharged into the room. The terminal unit comprises a plurality of high velocity nozzles wherein conditioned air from the CAH is discharged into a venturi to induce an air flow through the terminal unit. The diverging section of the venturi transmits the mixed supply air through an outlet to the system ductwork which is connected the diffusers in the room. An inlet is provided for transmitting induced air flow from the room to the heat transfer heat exchanger in the terminal unit.

The heat transfer heat exchanger, used for heating or cooling, communicates with the terminal unit intake to control the temperature of the return air just prior to mixing in the venturi. The heat transfer heat exchanger, when operating in a cooling mode, includes a continuous chilled water supply, and when in a heating mode includes a hot water supply.

The air powered terminal unit is designed for mixing tempered room air with cold (or hot) primary air in proportion to the desired induction rate. Heat loss or gain and contaminated air are picked up as the re-circulated air is drawn from the room, for example, from the ceiling. The heating or cooling capacity provided by a water or electric heat exchanger in the terminal unit tempers (heat up or cool down) the return air before mixing with the primary air from the CAH.

The venturi in the terminal unit acts as an air mixing chamber. The venturi chamber will regain the system pressure. The regained balanced air pressure will discharge the mixed supply air through outlet 112. The discharged supply air can than be used to feed a single or multiple ducts and/or diffusers.

The terminal unit can be equipped with a primary air damper as well as a supply air discharge damper. The heat exchanger may comprise a thermostat, damper and sensor which monitors the sensible cooling performance in the room. An actuator may be used to operate the dampers and the thermostat. A CO2 or temperature sensor/control device may regulate the ratio between the primary air from the CAH and the secondary air from the room return. The supply air discharged from the terminal unit may be delivered to the room as variable volume or constant volume.

In the terminal unit the functions of air movement and the heating/cooling performance are separated. Demand for zone comfort (temperature and air movement) can be met by conditioning supply air decentralized in the zone dedicated to the active terminal unit. Processing lower quantities of primary air from the CAH (approximately 30% of the total air supply to the conditioned room) allows a reduction in size of the upstream air handling products (central air handling) and thus allows energy savings by way of reduced fan power. Smaller units will require less space in the ceiling and thus can positively affect ceiling heights. Further, the inventive terminal unit operates more quietly when compared to currently available terminal air handling units.

The unit cooling capacity is preferably limited to the sensible heat load in the conditioned space. Any outside air ventilation load will be handled by the primary air handler (CAH). The required latent cooling performance can be achieved through variance of the primary air flow (typically 100 cfm to 300 cfm) and air absolute humidity conditions.

To assure adequate latent performance (dehumidification) the unit may use lower temperature primary air (absolute min 46° F.<55° F.). The primary air quantity is selected to fulfill adequate latent cooling and sufficient heating capacity at a flow rate equal or greater than the outside air ventilation rate for the space to be conditioned by each unit.

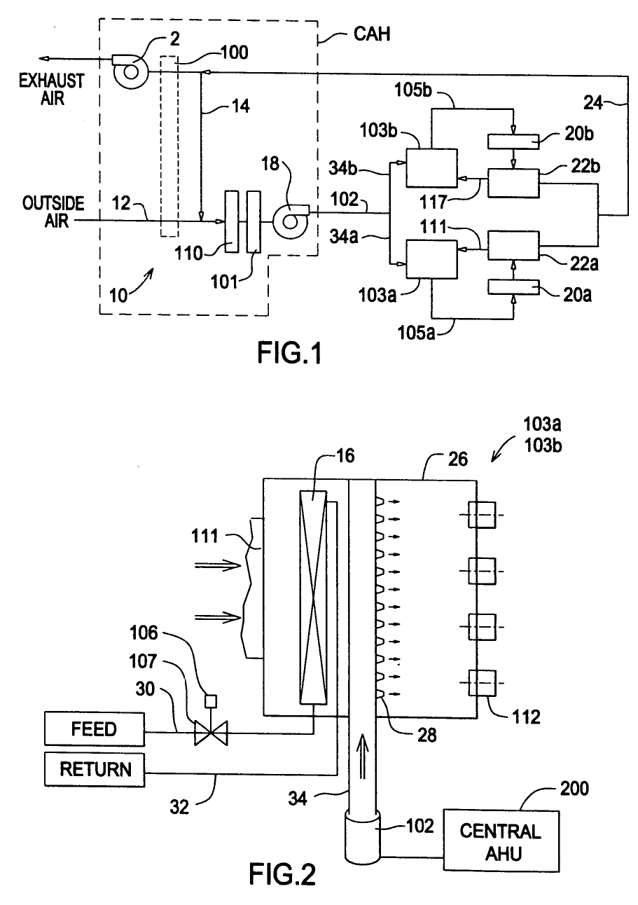

FIG. 1 is a schematic diagram illustrating the air flow for the system of this invention. Fresh or outside air is brought into the system via an inlet conduit or duct 12. Duct 12 may be routed directly to a central air handing unit (CAH) cooling heat exchanger 110, or it may optionally be connected to a heat or enthalpy recovery exchanger 100. Duct 12 may also be connected to a recycled air conduit or duct 14. Dampers (not shown) known in the art may be utilized throughout the system as appropriate.

Air brought in through duct 12 is chilled by the cooling heat exchanger 110 in the central air handing unit and or heated by a heating heat exchanger 101. The air is blown by a fan 18 into duct or conduit 102. Duct 102 distributes the air to one or more terminal units 103a and 103b. Load control and temperature control is primarily accomplished by the variable capacity of the heat exchanger 16 (see FIG. 2) and secondarily by variation of the primary air flow 34. Primary air flow is delivered to each unit 103a and 103b by duct 102 through ducts 34a and 34b.

Terminal units 103a and 103b control the amount of air sent, via duct 105a and 105b to each diffuser 20a and 20b. Each diffuser 20a and 20b controls air distribution into each room 22a and 22b.

Return air collected from rooms 22a and 22b moves back to the terminal units 103a and 103b via ducts 111 and 117, respectively. The returned air may also be vented to the outside by duct 24 through fan 2. The exhaust air may optionally be passed through a heat recovery device 100.

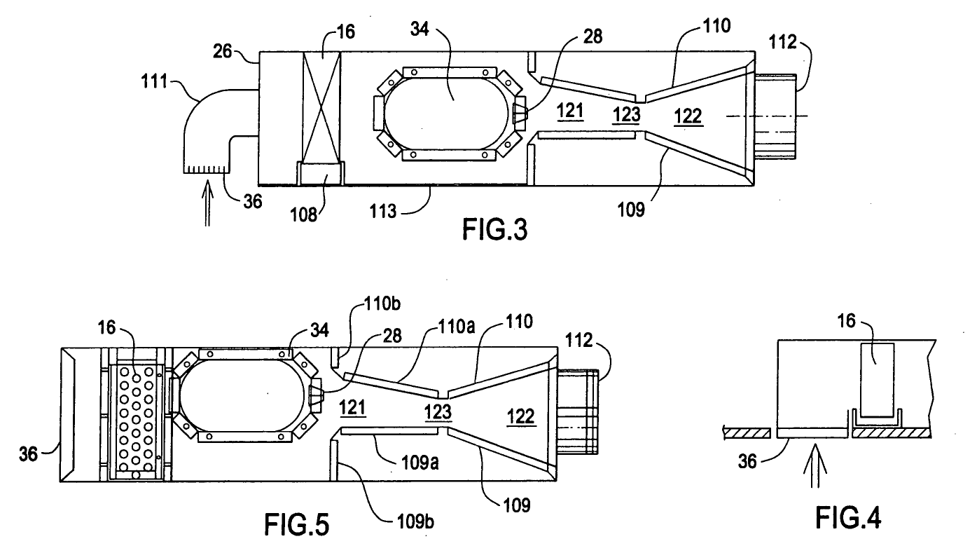

FIG. 2 is a plan view of a terminal housing. FIG. 3 is a side cross-sectional view of a terminal unit. The figures illustrate a terminal unit comprising a venturi section. The venturi section is formed by walls 109, 110 (FIG. 5) having a converging section 121, a venturi throat 123 and a diverging section 122.

The venturi produces a low pressure induced flow by means of the venturi effect. Primary air in the primary air duct 34 is directed to multiple high velocity nozzles 28. The flow of primary air from the nozzles through venturi throat 123 induces a flow of return air from the room through duct 111 or 117. The room air flows through a grill work 36 (FIG. 4) in the terminal unit or alternatively through the return air intake ducts 111,117. Primary air pressure from duct 34 can be regained by segmenting the diverging section 122.

Chilled and/or heated water is supplied to the heat exchanger 16 via conduits 30, 32. The supply water is maintained at least 1° F. above the room dew point to avoid any condensation formation on heat exchanger 16 during normal operation of the system. In the alternative, the supply water can be controlled for each terminal unit by a thermostat 106 and/or a regulating valve 107. In case of condensation from heat exchanger 16, a drip pan 108 accumulates any condensate water, see FIG. 3. Any accumulated condensate water is then drained from the drip pan via a drain pipe, not shown.

The primary air is cooled or heated and humidified or dehumidified at the central air handling unit CAH remote from the terminal unit, then ducted to terminal units 103a, 103b through ducts 102 and 34a and 34b.

Primary air received from the CAH is injected by nozzles 28 into the venturi chamber, mixed with the induced flow room air in the converging section 121 (mixing chamber), and then discharged as fully mixed supply air downstream of the diverging portion 122 through the supply outlet 112 back into each room 22a and 22b. The supply outlet 112 may consist of one or multiple duct connections supplying room air diffusers as shown in FIG. 1.

For commissioning and service the bottom cover 113 is removable and provides access to the heat exchanger 16 and pan 108. The lower part of the primary air ducts 34a and 34b is removable for ease of access to the nozzles 28.

FIG. 4 illustrates an alternate arrangement for the room air or return air grill work 36.

FIG. 5 illustrates an alternate side cross-sectional view of the active chilled terminal unit with the venturi device. The primary air is ducted to the one or more terminals through the inlet duct 34. The high pressure chamber hosting the nozzles 28 is connected to the terminal housing on only one side.

The converging section of the venturi comprises walls 109a, 110a, 109b and 110b. The diverging section of the venturi comprises walls 109, 110.

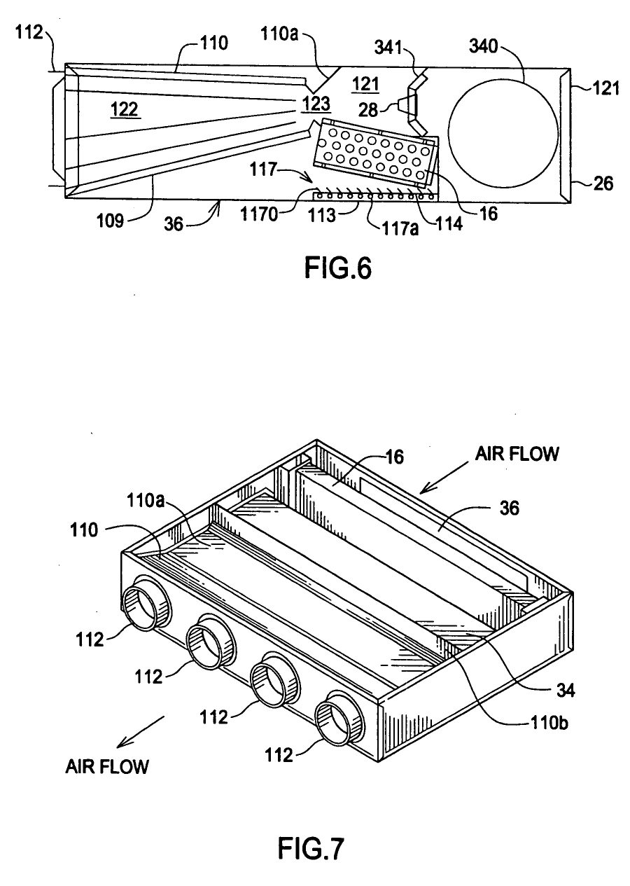

FIG. 6 illustrates an alternative version of the active chilled terminal unit with the venturi device. The primary air is ducted to each terminal unit through inlet 34. High pressure chamber 340 hosting the primary air nozzles 28 is formed by the main terminal housing 26 and a dividing wall 341 hosting the nozzles 28. The flow of room air or return air is induced through a grill work 36 in the terminal or in the alternative through the return air intake in the duct cover 113. Primary air injected by the nozzles in the venturi chamber 122 mixes with the induced, conditioned room air following the diverging chamber (109, 110) and is discharged as fully mixed supply air through the supply outlet 112 and returned to each room 22a, 22b.

Drain pan 114 is a safety feature for applications where the heat exchanger is operated below the dew point of the room air. Drain pan 114 collects condensation dripping off of heat exchanger 16. Piping to drain the water (not shown) may also be connected to drain pan 114.

Linear bar grill 117 functions as a water separator. Grill 117 comprises a plurality of bars 1170 extending in parallel fashion with a gap therebetween to accommodate an air flow. Condensation dripping from the heat exchanger 16 is separated from incoming air and flows along a groove 117a in each bar so that the water is not re-entrained in the incoming air flow. The water is collected in the drain pan 114.

FIG. 7 is a perspective view of the embodiment in FIG. 5. Primary air flows from duct 34 through nozzles 28 and into venturi (121, 122, 123), thereby inducing a return air flow from the room. The induced air flow is drawn through grill work 36 into the unit. The induced air flow passes through heat exchanger 16. The primary air flow and induced air flow mix in the converging section (121) and diverging section (122) of the venturi. The mixed air exits the unit through each outlet 112. In this embodiment each outlet 112 is circular to accommodate connections to circular ductwork, however each outlet 112 may also be rectangular or any other form suited to connect to outlet ductwork.

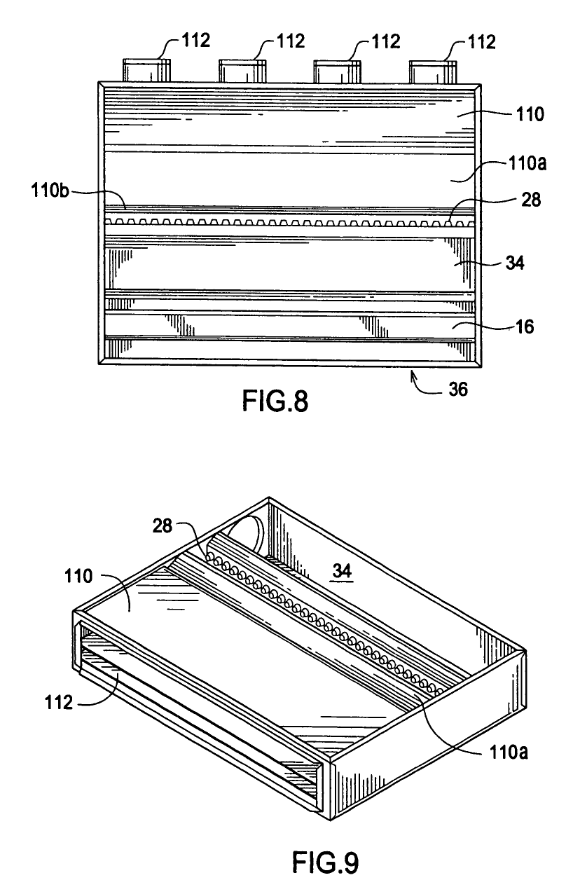

FIG. 8 is a plan view of the embodiment in FIG. 7. Nozzles 28 are disposed across the width of the unit. Heat exchanger 16 is disposed across the width of the unit so the entire induced air flow passes through the heat exchanger 16.

FIG. 9 is a perspective view of the embodiment in FIG. 6. The unit is constructed of sheet metal known in the art. Outlet 112 in this embodiment comprises a slot extending across the width of the unit. This slot configuration allows connection of the unit to rectangular duct.

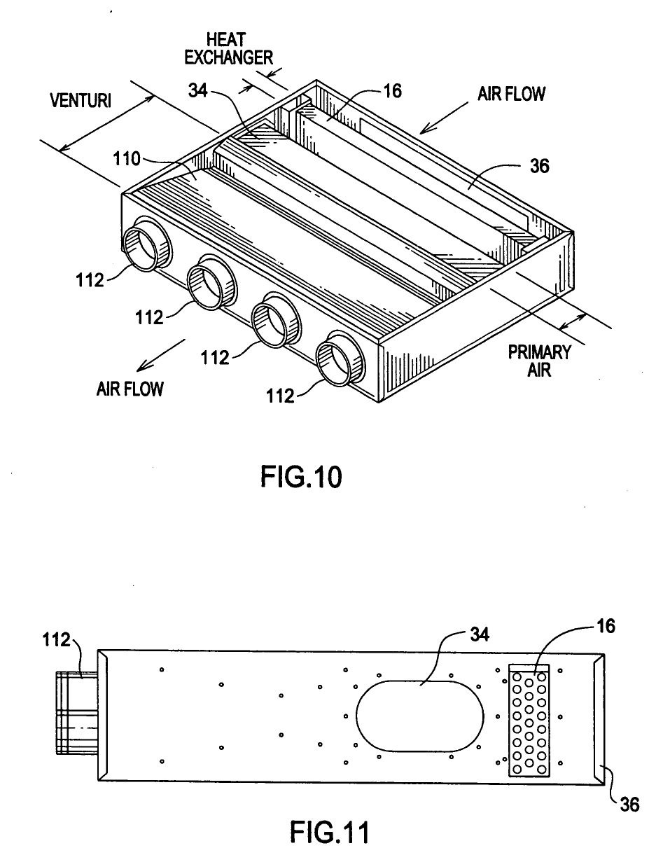

FIG. 10 is a perspective view of the embodiment in FIG. 5. Each unit comprises a venturi section, a primary air section, and a heat exchanger section. Induced air flow enters through grill works 36. Mixed air flow (primary+induced) exits the unit through outlets 112.

FIG. 11 is a side view of the embodiment in FIG. 5.

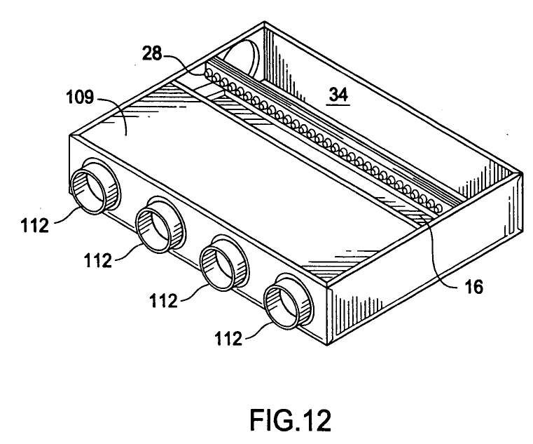

FIG. 12 is a perspective view of the embodiment in FIGS. 6 and 9.

In operation the inventive unit performed in the configurations described in this specification. The differences between each configuration were tested with respect to the diameter of the nozzles 28.

The following table summarizes the testing results.

| | Prime | | | | | |
|---|---|---|---|---|---|---|
| | Air | Prime | Room | | Dis- | |
| | flow | Air | air | Discharge | charge | |
| Con- | (CFM) | Pressure | flow | Air flow | Pressure | Induct |
| figuration | (34) | (in WC) | (CFM) | (CFM) | (in WC) | Rate |
| 1) Nozzle φ | 192 | 0.8 | 178 | 370 | 0 | 0.93 |
| 0.500″ | | | | | | |
| Nozzle φ | 264 | 0.8 | 220 | 484 | 0 | 0.80 |
| 0.593″ | | | | | | |
| 2) Nozzle φ | 221 | 0.8 | 426 | 647 | 0 | 1.92 |
| 0.593″ | | | | | | |
| | 239 | 0.8 | 137 | 376 | 0.1 | 0.57 |
| 3) Nozzle φ | 128 | 0.8 | 350 | 478 | 0 | 2.74 |
| 0.593″ | | | | | | |
| | 128 | 0.8 | 178 | 306 | 0.05 | 1.39 |
| Nozzle φ | 212 | 0.8 | 495 | 707 | 0 | 2.33 |
| 0.750″ | | | | | | |
| | 212 | 0.8 | 319 | 531 | 0.06 | 1.51 |
| Design | 170-250 | 0.3-2.0 | 430-750 | 600-1,000 | 0.15- | 2.5-3.2 |
| Range | | | | | 0.40 | |

Configuration 1 is shown in FIG. 3. The primary air duct 34 and nozzles 28 are substantially aligned with the venturi converging section 121.

Configuration 2 is shown in FIG. 5. Duct 34 and nozzles 28 are arranged off-center from the converging section 121.

Configuration 3 is shown in FIG. 6. Heat exchanger 16 is downstream of plenum 340. In this configuration heat exchanger 16 forms one side of converging section 121.

The following design parameters used during the testing are examples only and are not intended to limit the scope of the invention. Housing dimensions are 36×49×9.5 in including a drain pan for safety. The supply air duct to the diffusers has the same diameter as the diffusers, approximately 5″ to 6″. The recirculation air (room air) duct to the terminal unit is 6″×32″=192 in² (hydraulic diameter=10.1) and 750 cfm at 1,000 ft/m. Primary air duct is 5.25×9.375=49.2 in² (hydraulic diameter=6.725) and 250 cfm at 1,000 ft/m. The nozzles 28 are 1″ diameter×32≈25 in². The room is 1,000 ft² with 1 cfm/ft² gives approximately 1,000 cfm (4×Omni 235 cfm, 0.1 in wg, throw 4-5-11, NC 28). The cooling load=20 btu/h/ft²=20,000 btu/h at approximately 750 cfm. The sensible load to be approximately 50% of the total=10,000 btu/h. The heating load=12.5 btu/h/ft2=12,500 btu/h at approximately 750 cfm.

For the testing the following system parameters were applied. The air flow rates range is:

| | |
|---|---|
| Prime air flow (34): | 170 cfm-250 cfm |
| Supply air flow target: | 600 cfm-1,000 cfm |

Typical supply air ratio for current common designs is 2.5 to 3.2. The return air from the room (22a, 22b) flow is in the range of 430 cfm to 750 cfm.
The air system pressure range targets are:

| | |
|---|---|
| Prime air pressure: | 0.30 in WC to 2.00 in WC |
| Supply air pressure: | 0.15 in WC to 0.40 in WC |
| Return air pressure: | −0.01 in WC to −0.15 in WC |

The diffuser (20a, 20b) throw target is in the range of 4 ft to 12 ft.
The temperature ranges are:

| | |
|---|---|
| Room air temperature: | 73° F.-77° F. |
| Supply air temperature cooling: | 61° F.-66° F. |
| Supply air temperature heating | 78° F.-85° F. |
| Prime air temperature cooling | 48° F.-55° F. |
| Prime air temperature heating | 73° F.-78° F. |
| Water temperature cooling: | 57° F.-64° F. |
| Water temperature heating: | 95° F.-140° F. |

The water flow rates to heat exchanger (16) are:

| | |
|---|---|
| Cooling | 2 gal/min-6 gal/min |
| Heating | 1 gal/min-4 gal/min |

The system cooling capacity is 25 BTU/H/ft². The heating capacity is 12.5 BTU/H/ft².

Although forms of the invention have been described herein, it will be obvious to those skilled in the art that variations may be made in the construction and relation of parts without departing from the spirit and scope of the invention described herein.

I claim:

1. An air powered terminal unit comprising:
a housing;
a fluid to air heat exchanger;
an induced flow air inlet upstream of the heat exchanger;
a venturi downstream of the heat exchanger;
a nozzle cooperatively disposed with the venturi so as to direct a primary air jet discharged from the nozzle through the venturi, such that an air flow through the heat exchanger is induced; and
an outlet downstream of the venturi for discharging a mixture of the induced flow air and the primary air.

2. The air powered terminal unit as in claim 1 further comprising:
a water separator cooperatively disposed with the air heat exchanger; and
a drain pan cooperatively disposed with the water separator.

3. An air powered terminal unit system comprising:
an air powered terminal unit comprising:
a housing;
a fluid to air heat exchanger;
a water separator cooperatively disposed with the air heat exchanger;
a drain pan cooperatively disposed with the water separator;
an air inlet upstream of the heat exchanger;
a venturi downstream of the heat exchanger;
a nozzle cooperatively disposed with the venturi so as to direct an air jet through the venturi;
an air outlet downstream of the venturi;
a heat recovery exchanger upstream of the air powered terminal unit;
a fluid to air heat exchanger downstream of the heat recovery exchanger and upstream of the air powered terminal unit;
a fan upstream of the air powered terminal unit discharging air into the air powered terminal unit through the nozzle, the air having a primary air pressure;
the air outlet discharging air into a room; and
the air inlet receiving air from the room.

4. The air powered terminal unit as in claim 1, wherein the nozzle is disposed between the heat exchanger and the venturi.

5. The air powered terminal unit as in claim 1 further comprising a control valve connected to a heat exchanger fluid supply.

6. The air powered terminal unit as in claim 1 further comprising a mixing chamber upstream of the venturi.

7. The air powered terminal unit in claim 6, wherein the mixing chamber is downstream of the heat exchanger.

8. The air powered terminal unit in claim 3, wherein the primary air static pressure is regained downstream of the venturi.
